(19) United States
(12) Patent Application Publication
(10) Pub. No.: US 2024/0172790 A1
(43) Pub. Date: May 30, 2024

(54) AEROSOL GENERATING DEVICE BASED ON ULTRASOUND VIBRATION AND METHOD THEREOF

(71) Applicant: KT&G CORPORATION, Daejeon (KR)

(72) Inventors: Wonkyeong LEE, Gyeonggi-do (KR); Min Kyu KIM, Seoul (KR); Jung Ho KIM, Seoul (KR); Hyung Seok LEE, Seoul (KR); Heon Jun JEONG, Seoul (KR); Byung Sung CHO, Gyeonggi-do (KR)

(73) Assignee: KT&G CORPORATION, Daejeon (KR)

(21) Appl. No.: 17/789,879

(22) PCT Filed: Apr. 6, 2022
(86) PCT No.: PCT/KR2022/004964

§ 371 Date: Dec. 8, 2022

(30) Foreign Application Priority Data
May 31, 2021 (KR) 10-2021-0070107
Jul. 22, 2021 (KR) 10-2021-0096701

(51) Int. Cl. A24F 40/05; A24F 40/10; A24F 40/53; B06B 1/02

(52) U.S. Cl. CPC A24F 40/05; A24F 40/10; A24F 40/53; B06B 1/0215; B06B 2201/55; B06B 2201/77

(57) ABSTRACT

According to an embodiment of the present disclosure, a method of controlling an aerosol generating device that generates an aerosol based on ultrasonic vibration of a vibrator of the aerosol generating device is provided. The method includes: operating, based on power of the aerosol generating device being turned on, the aerosol generating device in a preheat mode for preheating the vibrator; operating, based on the preheat mode being completed, the aerosol generating device in a power repetition control mode wherein supplying of power to the vibrator and cutting off supply of the power to the vibrator are alternately repeated; and operating, based on a puff of a user being sensed while operating in the power repetition control mode, the aerosol generating device in a puffing mode wherein power is supplied to the vibrator to generate the aerosol.

### TECHNICAL FIELD

Embodiments of the present disclosure relate to an aerosol generating device and a method of controlling the aerosol generating device, and more particularly, to an aerosol generating device that generates aerosols by using ultrasonic vibration and a method of controlling the aerosol generating device.

### BACKGROUND ART

There has been an increasing demand for an aerosol generating device that generates aerosols in a non-combustible manner to replace a method of burning a cigarette to generate aerosols. An aerosol generating device is, for example, a device that generates and supplies aerosols to a user in a non-combustible manner from an aerosol generating material, or generates aerosols having flavors by passing a vapor generated from an aerosol generating material through a fragrance medium.

Aerosol generating devices may be classified into various types based on differences in methods or units generating aerosols. Among them, an aerosol generating device that generates aerosols by using ultrasonic vibration is a device that generates aerosols by ultrasonic vibration generated by applying an alternating voltage to a vibrator. In particular, an aerosol generating device based on ultrasonic vibration generates aerosols by a method of reducing the viscosity of a liquid in contact with a vibrator by heat generated by the vibrator and then splitting the liquid by ultrasonic vibration at an oscillation frequency of frequencies of an alternating voltage.

### DISCLOSURE OF INVENTION

### Technical Problem

Technical problems solved by embodiments of the present disclosure include a need for an aerosol generating device which may stably operate, and for a method of controlling the aerosol generating device.

### Solution to Problem

A method according to an embodiment of the present disclosure for solving the technical problem includes, when power of the aerosol generating device is turned on, operating in a preheat mode for preheating a vibrator, when the preheating is completed, operating in a power repetition control mode wherein supplying of power to the vibrator and cutting off of power supply to the vibrator are alternately repeated, and when a user's puff is sensed while operating in the power repetition control mode, operating in a puffing mode wherein power is supplied to the vibrator to generate aerosols.

A device according to another embodiment of the present disclosure for solving the technical problem includes a cartridge, a vibrator configured to vibrate in response to a received control signal, a vibration accommodation unit configured to receive vibration from the vibrator and vibrate an aerosol generating substrate discharged from the cartridge to generate aerosols, and a processor configured to generate control signals for controlling the vibrator, wherein the processor is further configured to: preheat the vibrator when power of the aerosol generating device is turned on; when the preheating is completed, operate in a power repetition control mode wherein supplying of power to the vibrator and cutting off of power supply to the vibrator are alternately repeated; and, when a user's puff is sensed while operating in the power repetition control mode, generate a control signal controlling in the aerosol generating device to operate a puffing mode wherein power is supplied to the vibrator to generate aerosols.

An embodiment of the present disclosure may provide a non-transitory computer-readable recording medium storing a program for executing the method.

### Advantageous Effects of Invention

An aerosol generating device based on ultrasonic vibration according to an embodiment of the present disclosure may operate more stably than an aerosol generating device in the related art to provide a user with the same amount of aerosols from a first puff to a last puff.

In addition, the aerosol generating device based on ultrasonic vibration may prevent a vibrator in the device from being damaged.

### BRIEF DESCRIPTION OF DRAWINGS

FIG. 1 is a block diagram of an aerosol generating device according to an embodiment;

FIG. 2 is a schematic diagram of an aerosol generating device related to the embodiment shown in FIG. 1;

FIG. 3 is a flowchart illustrating an example of a method of controlling an aerosol generating device based on ultrasonic vibration, according to an embodiment of the present disclosure;

FIG. 4 is a graph schematically illustrating a method of controlling power supplied to a vibrator shown in FIG. 3;

FIG. 5 is a flowchart illustrating another example of a method of controlling an aerosol generating device based on ultrasonic vibration, according to an embodiment of the present disclosure;

FIG. 6 schematically illustrates a graph of power vs. time of a vibrator operating in a puffing mode;

FIG. 7 is a graph illustrating a case in which an event is generated in a puffing high state;

FIG. 8 is a graph illustrating a case in which an event is generated in a puffing low state;

FIG. 9 is a flowchart illustrating another example of a method of controlling an aerosol generating device based on ultrasonic vibration, according to an embodiment of the present disclosure;

FIG. 10 schematically illustrates a graph of power vs. time, in which a preheat mode is omitted;

FIG. 11 is a flowchart illustrating another example of a method of controlling an aerosol generating device based on ultrasonic vibration, according to an embodiment of the present disclosure;

FIG. 12 is a graph for schematically explaining a puff wait heat number described in FIG. 11;

FIG. 13 illustrates a graph of power vs. time, to describe a case in which power is supplied to a vibrator when a puffing high time is set to zero; and

FIG. 14 is a flowchart explaining embodiments shown in FIGS. 3 to 13.

### BEST MODE FOR CARRYING OUT THE INVENTION

According to embodiments, a method of controlling an aerosol generating device that generates an aerosol based on ultrasonic vibration of a vibrator of the aerosol generating device is provided. The method is performed by at least one processor, and the method includes: operating, based on power of the aerosol generating device being turned on, the aerosol generating device in a preheat mode for preheating the vibrator; operating, based on the preheat mode being completed, the aerosol generating device in a power repetition control mode wherein supplying of power to the vibrator and cutting off supply of the power to the vibrator are alternately repeated; and operating, based on a puff of a user being sensed while operating in the power repetition control mode, the aerosol generating device in a puffing mode wherein power is supplied to the vibrator to generate the aerosol.

According to one or more embodiments, the method further includes switching from the power repetition control mode to the preheat mode based on repeating power control, of supplying the power to the vibrator and cutting off the supply of the power to the vibrator, a certain number of times.

According to one or more embodiments, the preheat mode includes applying a fixed amount of power to the vibrator during the preheat mode.

According to one or more embodiments, a magnitude of a voltage applied in the preheat mode is any one voltage selected from 10 volts to 15 volts.

According to one or more embodiments, the puffing mode sequentially includes: a first section of applying a first voltage to the vibrator; a second section of applying a second voltage less than the first voltage to the vibrator; and a blocking section of blocking a voltage to the vibrator.

According to one or more embodiments, a ratio of time lengths of the first section, the second section, and the blocking section is a preset ratio value.

According to one or more embodiments, the ratio of the time lengths is 2:3:1.

According to one or more embodiments, the method further includes switching from the puffing mode to the power repetition control mode based on an inhalation of the user ending before the first section ends.

According to one or more embodiments, the method further includes switching from the puffing mode to the power repetition control mode based on an inhalation of the user ending before the second section ends.

According to one or more embodiments, the puffing mode sequentially includes: a second section of applying a second voltage less than a first voltage to the vibrator; and a blocking section of blocking a voltage to the vibrator, and wherein the operating in the puffing mode includes operating by including the second section and the blocking section in the puffing mode, without operating in a first section before the second section, based on an obtained value for determining a length of the first section being less than or equal to zero, the first section being a section of applying the first voltage to the vibrator.

According to one or more embodiments, the operating in the puffing mode includes maintaining power blocking for the vibrator until the power blocking state ends, such that the voltage to the vibrator is blocked despite sensing of an inhalation of the user during the power blocking state.

According to one or more embodiments, the operating in the power repetition control mode includes controlling the vibrator with a pulse width modulation (PWM) signal having a duty cycle of a value selected from among a range of 40% to 60%.

According to one or more embodiments, the method further includes: detecting, after the power of the aerosol generating device is turned on, an idle period based on a recent time the aerosol generating device is used, and based on the detected idle period being less than a preset reference time, entering the power repetition control mode without first preheating the vibrator.

According to embodiments, a non-transitory computer-readable recording medium storing a program for executing the method according to an embodiment is provided.

According to embodiments, an aerosol generating device is provided. The aerosol generating device includes: a cartridge; a vibrator configured to vibrate in response to a received control signal; a vibration accommodation unit configured to receive vibration from the vibrator and vibrate an aerosol generating substrate discharged from the cartridge to generate an aerosol; and a processor configured to generate at least one control signal for controlling the vibrator, wherein the processor is further configured to: operate, based on power of the aerosol generating device being turned on, in a preheat mode that includes controlling the vibrator to preheat, operate, based on the preheat mode being completed, in a power repetition control mode that includes causing supply of power to the vibrator and cutting off of the supply of power to the vibrator to be alternately repeated, and operate, based on a puff of a user being sensed while operating in the power repetition control mode, in a puffing mode that includes causing power to be supplied to the vibrator to generate the aerosol.

According to one or more embodiments, the processor is further configured to switch from the power repetition control mode to the preheat mode based on repeating power control, of supplying the power to the vibrator and cutting off of the supply of the power to the vibrator, a certain number of times.

According to one or more embodiments, the preheat mode includes applying a fixed amount of power to the vibrator during the preheat mode.

According to one or more embodiments, the puffing mode sequentially includes: a first section of applying a first voltage to the vibrator; a second section of applying a second voltage less than the first voltage to the vibrator; and a blocking section of blocking a voltage to the vibrator.

According to one or more embodiments, the processor is further configured to switch from the puffing mode to the power repetition control mode based on an inhalation of the user ending before the first section ends.

According to one or more embodiments, the processor is further configured to switch from the puffing mode to the power repetition control mode based on an inhalation of the user ending before the second section ends.

### MODE FOR THE INVENTION

Although general terms currently widely used have been selected for the description of embodiments, the meaning of the terms may vary depending on the intention or precedent of one skilled in the art to which the embodiments belong, the emergence of new technology, or the like. In addition, in certain cases, terms can be arbitrarily selected by the applicant. In such cases, the meaning of the terms will be described in detail at the corresponding portion in the description of the present disclosure. Accordingly, when interpreting the terms used for the description of the embodiments, it should be defined based on the meaning of the term and the contents of the present specification, rather than simply limiting the term to the name.

Throughout the specification, when a portion “includes” a certain component, this means that other elements may be further included, rather than excluding other elements, unless otherwise stated. In addition, the terms “-er”, “-or”, and “module” described in the specification mean units for processing at least one function and operation and can be implemented by hardware components or software components and combinations thereof.

Hereinafter, non-limiting example embodiments will now be described more fully with reference to the accompanying drawings, in which the non-limiting example embodiments are shown such that one of ordinary skill in the art may easily work embodiments the present disclosure. Embodiment of the present disclosure can, however, be embodied in many different forms and should not be construed as being limited to the non-limiting example embodiments set forth herein.

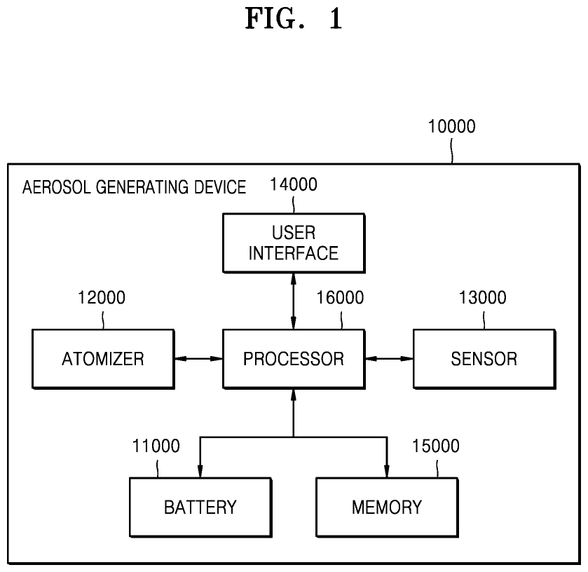

FIG. 1 is a block diagram of an aerosol generating device according to an embodiment.

Referring to FIG. 1, an aerosol generating device 10000 may include a battery 11000, an atomizer 12000, at least one sensor 13000, a user interface 14000, a memory 15000, and a processor 16000. However, the internal structure of the aerosol generating device 10000 is not limited to the structure shown in FIG. 1. According to some embodiments of the aerosol generating device 10000, it will be understood by one of ordinary skill in the art that some of the hardware components shown in FIG. 1 may be omitted or new components may be added.

For example, the aerosol generating device 10000 may include a main body (e.g., without a cartridge), in which case hardware components included in the aerosol generating device 10000 are located in the main body.

As another embodiment, the aerosol generating device 10000 may include a main body and a cartridge, in which case hardware components included in the aerosol generating device 10000 are located separately in the main body and the cartridge. Alternatively, at least some of hardware components included in the aerosol generating device 10000 may be located in the main body and the cartridge, respectively.

Hereinafter, an operation of each of the components will be described without being limited to a space in which each of the components in the aerosol generating device 10000 is located.

The battery 11000 supplies power to be used for the aerosol generating device 10000 to operate. That is, the battery 11000 may supply power so that the atomizer 12000 may convert an aerosol generating material into aerosols. In addition, the battery 11000 may supply power required for operations of other hardware components included in the aerosol generating device 10000 (e.g., the at least one sensor 13000, the user interface 14000, the memory 15000, and the processor 16000). The battery 11000 may be a rechargeable battery or a disposable battery.

For example, the battery 11000 may include a nickel-based battery (e.g., a nickelmetal hydride battery, and a nickel-cadmium battery) or a lithium-based battery (e.g., a lithium-cobalt battery, a lithium-phosphate battery, a lithium-titanate battery, a lithiumion battery, or a lithium-polymer battery). However, a type of the battery 11000 which may be used in the aerosol generating device 10000 is not limited thereto. According to embodiments, the battery 11000 may also include an alkaline battery or a manganese battery.

The atomizer 12000 receives power from the battery 11000 under the control by the processor 16000. The atomizer 12000 may receive power from the battery 11000 to convert an aerosol generating material stored in the aerosol generating device 10000 into aerosols.

The atomizer 12000 may be located in the main body of the aerosol generating device 10000. Alternatively, when the aerosol generating device 10000 includes the main body and the cartridge, the atomizer 12000 may be located in the cartridge or may be separately located in the main body and the cartridge. When the atomizer 12000 is located in the cartridge, the atomizer 12000 may receive power from the battery 11000 located in at least one of the main body and the cartridge. In addition, when the atomizer 12000 is separately located in the main body and the cartridge, components that require power in the atomizer 12000 may receive power from the battery 11000 located in at least one of the main body and the cartridge.

The atomizer 12000 generates aerosols from an aerosol generating material inside the cartridge. Aerosols refer to a floating matter in which liquid and/or solid fine particles are dispersed in a gas. Accordingly, aerosols generated from the atomizer 12000 may mean a state in which vaporized particles generated from an aerosol generating material and air are mixed. For example, the atomizer 12000 may convert a phase of the aerosol generating material into a gaseous phase through vaporization and/or sublimation. In addition, the atomizer 12000 may generate aerosols by granulating and discharging the aerosol generating material in a liquid and/or solid phase.

For example, the atomizer 12000 may generate aerosols from the aerosol generating material by using a method of ultrasonic vibration. The method of ultrasonic vibration may mean a method of generating aerosols by converting an aerosol generating material into aerosols with ultrasonic vibration generated by a vibrator.

Although not illustrated in FIG. 1, the atomizer 12000 may selectively include a heater that may heat an aerosol generating material by generating heat. The aerosol generating material may be heated by the heater, resulting in generating aerosols.

The heater may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater may be implemented by a metal wire, a metal plate on which an electrically conductive track is arranged, a ceramic heating element, or the like, but is not limited thereto.

For example, in an embodiment, the heater may be a portion of a cartridge. In addition, the cartridge may include a liquid delivery element and a liquid storage unit to be described below. An aerosol generating material accommodated in the liquid storage unit may be moved to the liquid delivery element, and the heater may heat the aerosol generating material absorbed by the liquid delivery element, thereby generating aerosols. For example, the heater may be wound around the liquid delivery element or arranged adjacent to the liquid delivery element.

As another example, the aerosol generating device 10000 may include an accommodation space that may accommodate a cigarette, and the heater may heat the cigarette inserted into the accommodation space of the aerosol generating device 10000. As the cigarette is accommodated in the accommodation space of the aerosol generating device 10000, the heater may be located inside and/or outside the cigarette. Accordingly, the heater may generate aerosols by heating an aerosol generating material in the cigarette.

The heater may include an induction heater. The heater may include an electrically conductive coil for heating a cigarette or a cartridge in an induction heating method, and the cigarette or the cartridge may include a susceptor which may be heated by the induction heater.

The aerosol generating device 10000 may include at least one sensor 13000. A result sensed by the at least one sensor 13000 may be transmitted to the processor 16000, and the processor 16000 may control the aerosol generating device 10000 to perform various functions such as controlling an operation of the atomizer 12000, restricting smoking, determining whether a cartridge (or a cigarette) is inserted, displaying a notification, or the like, according to the sensed result.

For example, the at least one sensor 13000 may include a puff detection sensor. The puff detection sensor may sense a user's puff based on at least one of a flow change of an airflow introduced from the outside, a pressure change, and sensing of sound. The puff detection sensor may sense a start timing and an end timing of a user's puff, and the processor 16000 may determine a puff period and a non-puff period according to the sensed start timing and the end timing of a puff.

In addition, the at least one sensor 13000 may include a user input sensor. The user input sensor may be a sensor that may receive a user's input, such as a switch, a physical button, a touch sensor, or the like. For example, the touch sensor may be a capacitive sensor that may sense the user's input by sensing a change in capacitance that occurs when a user touches a certain area formed of a metallic material. The processor 16000 may determine whether the user's input has occurred by comparing values before and after the change in capacitance received from the capacitive sensor. When a value obtained by comparing the values before and after the change in capacitance is greater than a preset threshold value, the processor 16000 may determine that the user's input has occurred.

In addition, the at least one sensor 13000 may include a motion sensor. Information about a movement of the aerosol generating device 10000, such as an inclination, movement speed, acceleration, or the like of the aerosol generating device 10000, may be obtained through the motion sensor. For example, the motion sensor may measure information about a state in which the aerosol generating device 10000 moves, a stationary state of the aerosol generating device 10000, a state in which the aerosol generating device 10000 is inclined at an angle within a certain range for a puff, and a state in which the aerosol generating device 10000 is inclined at an angle different from that during puff operation between each puff operation. The motion sensor may measure motion information of the aerosol generating device 10000 by using various methods known in the art. For example, the motion sensor may include an acceleration sensor capable of measuring acceleration in three directions of x-axis, y-axis, and zaxis, and a gyro sensor capable of measuring an angular speed in three directions.

In addition, the at least one sensor 13000 may include a proximity sensor. The proximity sensor refers to a sensor that detects the presence or distance of an approaching object or an object in the vicinity by using a force of an electromagnetic field, infrared light, or the like, without mechanical contact. Accordingly, it is possible to detect whether a user is approaching the aerosol generating device 10000.

In addition, the at least one sensor 13000 may include an image sensor. For example, the image sensor may include a camera configured to obtain an image of an object. The image sensor may recognize an object based on an image obtained by the camera. The processor 16000 may determine whether a user is in a situation for using the aerosol generating device 10000 by analyzing an image obtained through the image sensor. For example, when the user approaches the aerosol generating device 10000 near hisher lips to use the aerosol generating device 10000, the image sensor may obtain an image of the lips. The processor 16000 may analyze the obtained image and determine that it is a situation for the user to use the aerosol generating device 10000 when the obtained image is determined as lips. Accordingly, the aerosol generating device 10000 may operate the atomizer 12000 in advance, or may preheat the heater.

In addition, the at least one sensor 13000 may include a consumable attachment and detachment sensor which may sense the mounting or removal of a consumable (for example, a cartridge, a cigarette, or the like) that may be used in the aerosol generating device 10000. For example, the consumable attachment and detachment sensor may sense whether a consumable has contacted the aerosol generating device 10000, or determine whether the consumable is mounted or removed by the image sensor. In addition, the consumable attachment and detachment sensor may be an inductance sensor that senses a change in an inductance value of a coil which may interact with a marker of a consumable or a capacitance sensor that senses a change in a capacitance value of a capacitor which may interact with a marker of a consumable.

In addition, the at least one sensor 13000 may include a temperature sensor. The temperature sensor may sense a temperature at which the heater (or an aerosol generating material) of the atomizer 12000 is heated. The aerosol generating device 10000 may include a separate temperature sensor sensing a temperature of the heater, or the heater itself may serve as a temperature sensor instead of including a separate temperature sensor. Alternatively, a separate temperature sensor may be further included in the aerosol generating device 10000 while the heater serves as a temperature sensor. In addition, the temperature sensor may sense not only the temperature of the heater but also the temperature of internal components such as a printed circuit board (PCB), a battery, or the like of the aerosol generating device 10000.

In addition, the at least one sensor 13000 may include various sensors that measure information about a surrounding environment of the aerosol generating device 10000. For example, the at least one sensor 13000 may include a temperature sensor that may measure a temperature of a surrounding environment, a humidity sensor that measures a humidity of a surrounding environment, an atmospheric pressure sensor that measures a pressure of a surrounding environment, or the like.

The at least one sensor 13000 in the aerosol generating device 10000 is not limited to the above-stated types, and may further include various sensors. For example, the aerosol generating device 10000 may include a fingerprint sensor that may obtain fingerprint information from a user's finger for user authentication and security, an iris recognition sensor analyzing an iris pattern of a pupil, a vein recognition sensor that senses absorption of infrared rays of reduced hemoglobin in veins from an image capturing a palm, a face recognition sensor that recognizes feature points such as eyes, nose, mouth, facial contours, or the like in a two-dimensional (2D) or three-dimensional (3D) method, a radio-frequency identification (RFID) sensor, or the like.

The aerosol generating device 10000 may be implemented by selecting only some of various examples of the at least one sensor 13000 described above. In other words, the aerosol generating device 10000 may combine and use information sensed by at least one of the above-described sensors.

The user interface 14000 may provide the user with information about the state of the aerosol generating device 10000. The user interface 14000 may include various interfacing units, such as a display or a lamp for outputting visual information, a motor for outputting haptic information, a speaker for outputting sound information, inputoutput (I/O) interfacing units (e.g., a button or a touch screen) for receiving information input from the user or outputting information to the user, terminals for performing data communication or receiving charging power, and communication interfacing modules for performing wireless communication (e.g., Wi-Fi, Wi-Fi direct, Bluetooth, near-field communication (NFC), etc.) with external devices.

According to embodiments, the aerosol generating device 10000 may be implemented by selecting only some of various examples of the user interface 14000 described above.

The memory 15000 may be a hardware component configured to store various pieces of data processed in the aerosol generating device 10000, and the memory 15000 may store data processed or to be processed by the processor 16000. The memory 15000 may include various types of memories, such as random access memory (RAM) such as dynamic random access memory (DRAM), static random access memory (SRAM), etc., read-only memory (ROM), electrically erasable programmable read-only memory (EEPROM), etc.

The memory 15000 may store an operation time of the aerosol generating device 10000, the maximum number of puffs, the current number of puffs, at least one temperature profile, data on a user's smoking pattern, etc.

The processor 16000 controls general operations of the aerosol generating device 10000. The processor 16000 may be implemented as an array of a plurality of logic gates or may be implemented as a combination of a general-purpose microprocessor and a memory in which a program executable by the microprocessor is stored, and the program, when executed by the microprocessor, causes the processor 16000 to perform its functions described in the present disclosure. It will be understood by one of ordinary skill in the art that the processor 16000 may be implemented in other forms of hardware.

The processor 16000 analyzes a result of the sensing by the at least one sensor 13000, and controls processes that are to be performed subsequently.

The processor 16000 may control power supplied to the atomizer 12000 so that the operation of the atomizer 12000 is started or terminated, based on the result of the sensing by the at least one sensor 13000. In addition, based on the result of the sensing by the at least one sensor 13000, the processor 16000 may control the amount of power supplied to the atomizer 12000 and the time at which the power is supplied, so that the atomizer 12000 may generate an appropriate amount of aerosols. For example, the processor 16000 may control a current or voltage supplied to a vibrator of the atomizer 12000 so that the vibrator of the atomizer 12000 vibrates at a certain frequency.

In an embodiment, the processor 16000 may start the operation of the atomizer 12000 after receiving a user input for the aerosol generating device 10000. In addition, the processor 16000 may start the operation of the atomizer 12000 after sensing a user's puff by using a puff detection sensor. In addition, the processor 16000 may stop supplying power to the atomizer 12000 when the number of puffs reaches a preset number after counting the number of puffs by using the puff detection sensor.

The processor 16000 may control the user interface 14000 based on the result of the sensing by the at least one sensor 13000. For example, when the number of puffs reaches the preset number after counting the number of puffs by using the puff detection sensor, the processor 16000 may notify the user, by using at least one of a lamp, a motor, or a speaker, that the aerosol generating device 10000 will soon be terminated.

Although not illustrated in FIG. 1, an aerosol generating system may be configured by the aerosol generating device 10000 and a separate cradle. For example, the cradle may be used to charge the battery 11000 of the aerosol generating device 10000. For example, the aerosol generating device 10000 may be supplied with power from a battery of the cradle to charge the battery 11000 of the aerosol generating device 10000 while being accommodated in an accommodation space of the cradle.

One embodiment may also be implemented in the form of a non-transitory computer-readable recording medium including instructions executable by a computer, such as a program module executable by the computer. The non-transitory computer-readable recording medium may be any available medium that may be accessed by a computer and includes both volatile and nonvolatile media, and removable and non-removable media. In addition, the non-transitory computer-readable recording medium may include all computer storage media. The computer storage medium includes all of volatile and nonvolatile media, and removable and non-removable media implemented by any method or technology for storage of information such as computer-readable instructions, data structures, program modules or other data.

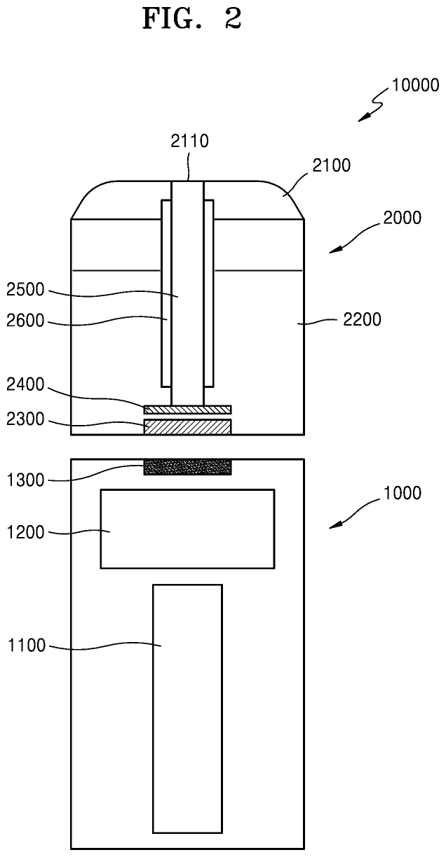

FIG. 2 is a schematic diagram of an aerosol generating device according to the embodiment shown in FIG. 1.

The aerosol generating device 10000 according to an embodiment shown in FIG. 2 includes the cartridge 2000, containing an aerosol generating material, and a main body 1000 supporting the cartridge 2000. The main body 1000 may include a battery 1100, a processor 1200, and a vibrator 1300 that may generate ultrasonic vibration under the control of the processor 1200. In addition, the cartridge 2000 may include a mouthpiece 2100, a liquid storage unit 2200, a vibration accommodation unit 2300, a liquid delivery element 2400, an aerosol discharge passage 2500, and an airflow passage 2600.

The cartridge 2000 may be coupled to the main body 1000 in a state in which the aerosol generating material is accommodated therein. For example, as a portion of the cartridge 2000 is inserted into the main body 1000 or a portion of the main body 1000 is inserted into the cartridge 2000, the cartridge 2000 may be mounted on the main body 1000. At this time, the main body 1000 and the cartridge 2000 may be maintained in a coupled stated by a snap-fit method, a screw coupling method, a magnetic coupling method, an interference fit method, or the like, but the coupling method of the main body 1000 and the cartridge 2000 is not limited by the above-stated methods.

The cartridge 2000 may include the mouthpiece 2100. The mouthpiece 2100 may be formed in a direction opposite to a portion coupled to the main body 1000, which is a portion inserted into the user's oral cavity. The mouthpiece 2100 may include a discharge hole 2110 for discharging aerosols generated from the aerosol generating material inside the cartridge 2000 to the outside.

The cartridge 2000 may contain an aerosol generating material in any one of, for example, a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

For example, the liquid composition may include one component of water, solvents, ethanol, plant extracts, spices, flavorings, and vitamin mixtures, or a mixture of these components. The spices may include menthol, peppermint, spearmint oil, various fruitflavored ingredients, or the like, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. Also, the liquid composition may include an aerosol forming substance, such as glycerin and propylene glycol.

For example, the liquid composition may include any weight ratio of glycerin and propylene glycol solution to which nicotine salts are added. The liquid composition may include two or more types of nicotine salts. Nicotine salts may be formed by adding suitable acids, including organic or inorganic acids, to nicotine. Nicotine may be a naturally generated nicotine or synthetic nicotine and may have any suitable weight concentration relative to the total solution weight of the liquid composition.

Acid for the formation of the nicotine salts may be appropriately selected considering the rate of nicotine absorption in the blood, the operating temperature of the aerosol generating device 10000, the flavor or taste, the solubility, or the like. For example, the acid for the formation of nicotine salts may be a single acid selected from the group consisting of benzoic acid, lactic acid, salicylic acid, lauric acid, sorbic acid, levulinic acid, pyruvic acid, formic acid, acetic acid, propionic acid, butyric acid, valeric acid, caproic acid, caprylic acid, capric acid, citric acid, myristic acid, palmitic acid, stearic acid, oleic acid, linoleic acid, linolenic acid, phenylacetic acid, tartaric acid, succinic acid, fumaric acid, gluconic acid, saccharic acid, malonic acid or malic acid, or a mixture of two or more acids selected from the group, but is not limited thereto.

The cartridge 2000 may include the liquid storage unit 2200 accommodating an aerosol generating material therein. When the liquid storage unit 2200 ‘accommodates an aerosol generating material’ therein, it means that the liquid storage unit 2200 functions as a container simply holding the aerosol generating material and that the liquid storage unit 2200 includes therein an element impregnated with (containing) an aerosol generating material, such as a sponge, cotton, fabric, or porous ceramic structure.

The aerosol generating device 10000 may include an atomizer that converts a phase of the aerosol generating material inside the cartridge 2000 to generate aerosols.

For example, the atomizer of the aerosol generating device 10000 may convert the phase of the aerosol generating material by using an ultrasonic vibration method in which the aerosol generating material is converted into aerosols with ultrasonic vibration. The atomizer may include a vibrator 1300 for generating ultrasonic vibration, the liquid delivery element 2400 for absorbing the aerosol generating material and maintaining the aerosol generating material in an optimal state for conversion into aerosols, and the vibration accommodation unit 2300 for generating aerosols by transmitting ultrasonic vibration to the aerosol generating material of the liquid delivery element 2400.

The vibrator 1300 may generate a short-period of vibration. Vibration generated from the vibrator 1300 may be ultrasonic vibration, and a frequency of the ultrasonic vibration may be, for example, 100 kHz to 3.5 MHz. The aerosol generating material may be vaporized and/or granulated by the short-period of vibration generated from the vibrator 1300 to be converted into aerosols.

The vibrator 1300 may include, for example, a piezoelectric ceramic, and the piezoelectric ceramic is a functional material capable of generating electricity (voltage) by a physical force (pressure) and conversely, when electricity is applied, converts the electricity into vibration (mechanical force). Accordingly, the vibration (physical force) may be generated by electricity applied to the vibrator 1300, and such a small physical vibration may split the aerosol generating material into small particles and convert the aerosol generating material into aerosols.

The vibrator 1300 may be in an electrical contact with a circuit by a pogo pin or a C-clip. Accordingly, the vibrator 1300 may receive current from the pogo pin or the C-clip to generate vibration. However, the type of an element connected to supply current or a voltage to the vibrator 1300 is not limited by the above description.

The vibration accommodation unit 2300 may perform a function of receiving the vibration generated by the vibrator 1300 and converting the aerosol generating material transmitted from the liquid storage unit 2200 into aerosols.

The liquid delivery element 2400 may deliver a liquid composition of the liquid storage unit 2200 to the vibration accommodation unit 2300. For example, the liquid delivery element 2400 may be a wick including at least one of a cotton fiber, a ceramic fiber, a glass fiber, a porous ceramic, but is not limited thereto.

In addition, the atomizer may be implemented by a vibration accommodation unit in the form of a mesh shape or plate shape, which performs both the functions of absorbing the aerosol generating material and maintaining the same in an optimal state for conversion to aerosols without using a separate liquid delivery element and the function of generating aerosols by transmitting vibration to the aerosol generating material.

In addition, the vibrator 1300 of the atomizer of the embodiment shown in FIG. 2 is arranged in the main body 1000, and the vibration accommodation unit 2300 and the liquid delivery element 2400 are arranged in the cartridge 2000, but are not limited thereto. For example, the cartridge 2000 may include the vibrator 1300, the vibration accommodation unit 2300, and the liquid delivery element 2400, and when a portion of the cartridge 2000 is inserted into the main body 1000, the main body 1000 may provide, through a terminal (not shown), power to the cartridge 2000, or supply a signal related to the operation of the cartridge 2000 to the cartridge 2000. Accordingly, the operation of the vibrator 1300 may be controlled.

At least a portion of the liquid storage unit 2200 of the cartridge 2000 may include a transparent material so that the aerosol generating material accommodated in the cartridge 2000 may be visually identified from the outside. The mouthpiece 2100 and the liquid storage unit 2200 may be entirely formed of a material such as transparent plastic, glass, or the like, or only a portion of the liquid storage unit 2200 may be formed of a transparent material.

The cartridge 2000 of the aerosol generating device 10000 may include the aerosol discharge passage 2500 and the airflow passage 2600.

The aerosol discharge passage 2500 may be formed inside the liquid storage unit 2200 and may be in fluid communication with the discharge hole 2110 of the mouthpiece 2100. Accordingly, aerosols generated from the atomizer may move along the aerosol discharge passage 2500 and may be delivered to the user through the discharge hole 2110 of the mouthpiece 2100.

The airflow passage 2600 is a passage through which external air may be introduced into the aerosol generating device 10000. External air introduced through the airflow passage 2600 may be introduced into the aerosol discharge passage 2500, or may be introduced into a space where aerosols are generated. Accordingly, aerosols may be generated by mixing external air with vaporized particles generated from the aerosol generating material.

For example, as shown in FIG. 2, the airflow passage 2600 may be formed to surround the outside of the aerosol discharge passage 2500. Accordingly, the form of the aerosol discharge passage 2500 and the airflow passage 2600 may be a double-pipe form in which the aerosol discharge passage 2500 is arranged in an inner side and the airflow passage 2600 is arranged outside the aerosol discharge passage 2500. Accordingly, external air may be introduced in a direction opposite to a direction in which aerosols move in the aerosol discharge passage 2500.

The structure of the airflow passage 2600 is not limited to the above description. For example, when the main body 1000 and the cartridge 2000 are coupled, the airflow passage 2600 may be a space formed between the main body 1000 and the cartridge 2000 and that performs fluid communication with the atomizer.

In the aerosol generating device 10000 according to the above-described embodiment, cross-sectional shapes of the main body 1000 and the cartridge 2000 in a direction across a longitudinal direction may be cross-sectional shapes which are substantially circular, elliptical, square, rectangular, or polygonal in various forms. However, the cross-sectional shape of the aerosol generating device 10000 is not limited as described above, and the aerosol generating device 10000 is not necessary limited to a structure that extends linearly when extending in the longitudinal direction. For example, the cross-sectional shape of the aerosol generating device 10000 may extend a long way while being curved in a streamlined shape or bent at a preset angle in a specific area to be easily held by the user, and the cross-sectional shape may change along the longitudinal direction.

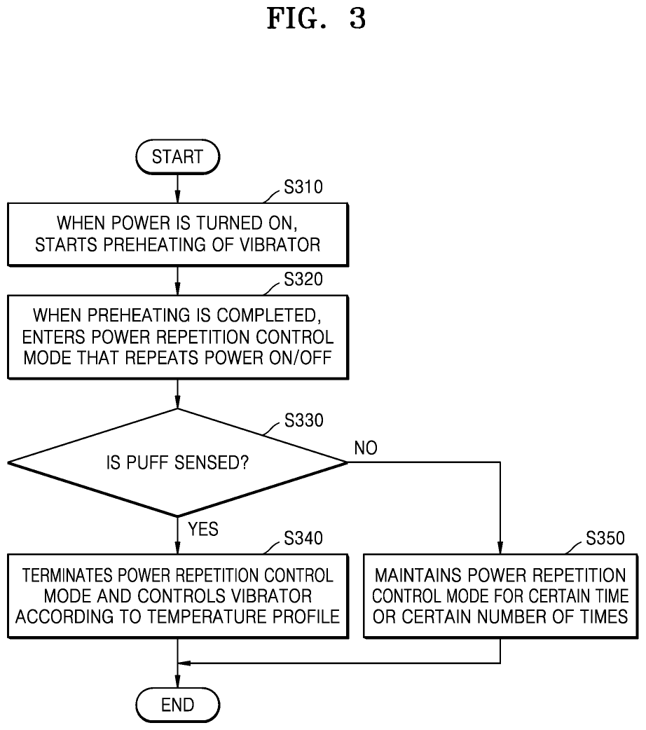

FIG. 3 is a flowchart illustrating an example of a method of controlling an aerosol generating device based on ultrasonic vibration, according to the present disclosure.

FIG. 3 schematically shows a control method performed by the processor described in FIGS. 1 and 2, wherein the processor may generate control signals and a vibrator may receive the control signals and operate based on a series of instructions included in the control signals. Hereinafter, an operation of the processor and corresponding operation of the vibrator receiving control signals is sequentially described with reference to FIG. 2.

First, in operation S310, when power of the aerosol generating device 10000 according to an embodiment of the present disclosure is turned on, the processor 1200 sends a control signal and the vibrator 1300 receiving the control signal starts preheating. In operation S310, an operation in which the vibrator 1300 receives the control signal from the processor 1200 may be referred to as a preheat mode.

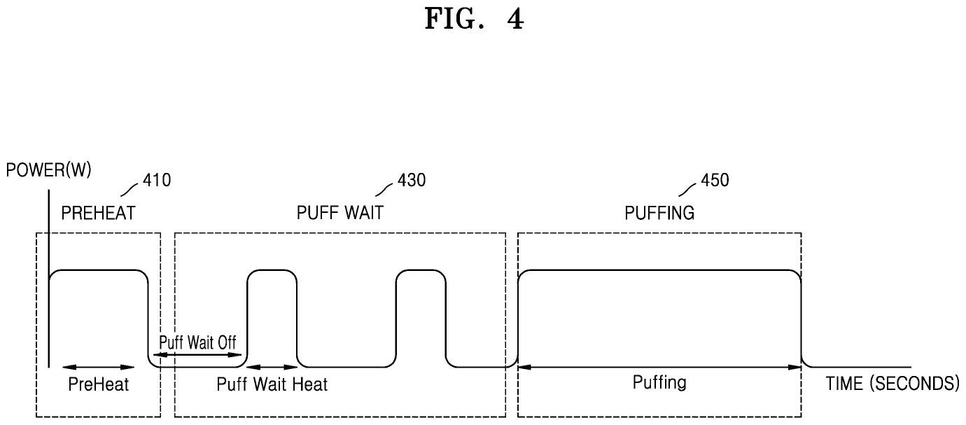

In operation S310, while the preheat mode continues, the vibrator 1300 may be provided with a fixed amount of power. The fixed amount of power provided to the vibrator 1300 is described below with reference to FIG. 4.

Then, in operation S320, when the preheating of the vibrator 1300 is completed, the vibrator 1300 may receive a control signal from the processor 1200 to enter a power repetition control mode. In operation S320, the power repetition control mode is a mode entered after preheating is completed, and means a mode in which supplying power to the vibrator 1300 and cutting off power supply to the vibrator 1300 are alternately repeated.

The power repetition control mode is a mode that waits until the user puffs through the aerosol generating device 10000. When the vibrator 1300 included in the aerosol generating device 10000 is continuously supplied with power even after preheating is completed (when a rated voltage is applied), the vibrator 1300 may be damaged as a temperature thereof rises exponentially.

In embodiments of the present disclosure, to prevent damage to the vibrator 1300, the power repetition control mode may be included as an intermediate mode in which, when preheating is primarily completed, the mode secondarily waits until the user's inhalation (puff) is sensed and aerosols are generated. In particular, the power repetition control mode repeats an operation of temporarily cutting off the entire power supply to the vibrator 1300 and then temporarily resuming the power supply to the vibrator 1300 again before an effect of preheating completely disappears, so that the vibrator 1300 may be prevented from damage caused by exponentially raising the temperature thereof, and at the same time, aerosols may be quickly generated when the user's inhalation is sensed.

In embodiments of the present disclosure, the power repetition control mode is differentiated from a method in the related art in that the power repetition control mode has a section in which the power supply to the vibrator 1300 is completely cut off after preheating is primarily completed at least once. A conventional aerosol generating device using a heating heater controls the heater in a way that steadily increases the temperature of the heater to a target temperature through a pulse width modulation (PWM) power signal or a proportional integral derivative (PID) control method. In this operation, even when the preheating of the heater is completed, the power supply to the heater is not completely cut off (stopped). This is because the heating heater may maintain a constant temperature through a ratio of the PWM power signals or PID control without cutting off the supply of power.

Because the vibrator 1300 of the aerosol generating device 10000 based on ultrasonic vibration has a characteristic of vibrating at a preset frequency, when the user does not use the device after preheating is completed after power is supplied to the vibrator 1300 for a certain period of time, there is essentially a section in which power supply to the vibrator 1300 is cut off for another certain period of time, so that a case in which the vibrator 1300 is overheated and damaged may be minimized. A schematic description of the power repetition control mode is described below with reference to FIG. 4.

The processor 1200 may determine whether the user's puff is sensed by the provided various puff detection sensors in operation S330, and when the user's puff is sensed while the vibrator 1300 is operating in the power repetition control mode, the power repetition control mode may be terminated and the vibrator 1300 may be controlled to generate aerosols. In particular, when the user's puff is sensed, the processor 1200 transmits a control signal to the vibrator 1300 to control aerosols to be generated due to the vibration of the vibrator 1300 according to a preset temperature profile.

In operation S350, when the user's puff is not sensed while the vibrator 1300 operates in the power repetition control mode, the processor 1200 may terminate the power repetition control mode after repeating the power repetition control mode a certain number of repetitions (a fixed number of times) or after a certain time (a fixed time) has elapsed.

FIG. 4 is a graph schematically illustrating a method of controlling power supplied to the vibrator shown in FIG. 3.

In FIG. 4, for convenience, the above-described power repetition control mode is abbreviated as a puff wait mode. In FIG. 4, the horizontal axis indicates time, and the vertical axis indicates power supplied to the vibrator 1300. In addition, although it is illustrated that the same power is supplied to the vibrator 1300 in a particular section in FIG. 4, voltage values applied to the vibrator 1300 in the particular section may be different from each other.

As shown in FIG. 4, the vibrator 1300 of an aerosol generating device according to an embodiment of the present disclosure receives a control signal from the processor 1200 and operates to generate aerosols while passing through a preheat mode 410, a puff wait mode 430, and a puffing mode 450. In particular, as described with reference to FIG. 2, as the vibration accommodation unit 2300 of a cartridge 2000 receiving vibration of the vibrator 1300 vibrates a liquid composition embedded in the liquid delivery element 2400, aerosols may be generated.

The vibrator 1300 may be preheated by receiving fixed power for a period set in the preheat mode. At this time, a voltage applied to supply power to the vibrator 1300 may be any one value selected from 10 volts (V) to 15 V. As an example embodiment, the voltage applied to the vibrator 1300 in the preheat mode may be 13 V.

When the preheating of the vibrator 1300 is completed, the preheat mode 410 is terminated and the puff wait mode 430 is entered. In the puff wait mode 430, a puff wait off section in which the power supply to the vibrator 1300 is temporarily cut off, and a puff wait heat section in which power to the vibrator 1300 is temporarily resumed, following the puff wait off section, may be alternately repeated.

The puff wait off section is a section in which power supplied to the vibrator 1300 is temporarily cut off, and a case in which the vibrator 1300 is damaged due to a sudden increase in temperature while excessively vibrating may be prevented. The puff wait heat section means a section in which power supply to the vibrator 1300 is temporarily resumed to convert a state of the vibrator 1300 that has been primarily preheated through the preheat mode 410 to a state that is easy to generate aerosols.

Because the puff wait off section and the puff wait heat section are sections in which power supplied to the vibrator 1300 is repeatedly turned on/off, a control signal for implementing the puff wait mode 430 may be a PWM signal having a constant duty cycle. As an example, the processor 1200 may generate a PWM signal having a duty cycle of 50% to implement the puff wait mode 430, and time lengths of the puff wait off section and the puff wait heat section of the vibrator 1300 receiving such a control signal are the same. As another example, the control signal for implementing the puff wait mode 430 may be also be a PWM signal having one value selected from a range of 40% to 60% as a duty cycle.

When the user's inhalation is sensed while operating in the puff wait mode 430, the vibrator 1300 may receive a control signal from the processor 1200 to operate in the puffing mode 450. In the puffing mode 450, aerosols may be generated by supplying a fixed amount of power to the vibrator 1300. When a preset number of puffs ends or a present puffing time elapses, the puffing mode 450 of the vibrator 1300 ends.

As shown in FIG. 4, according to an embodiment of the present disclosure, the aerosol generating device 10000 based on ultrasonic vibration may receive a control signal from the processor 1200 and includes the vibrator 1300 that sequentially operates in the preheat mode 410, the puff wait mode 430, and the puffing mode 450, so that overheating of the vibrator 1300 may be prevented, and aerosols may be stably provided to the user. In particular, the control method according to the embodiment of the present disclosure alternately repeats the puff wait off section and the puff wait heat section in the puff wait mode 430 of the vibrator 1300, so that the vibrator 1300 may be prevented from being damaged.

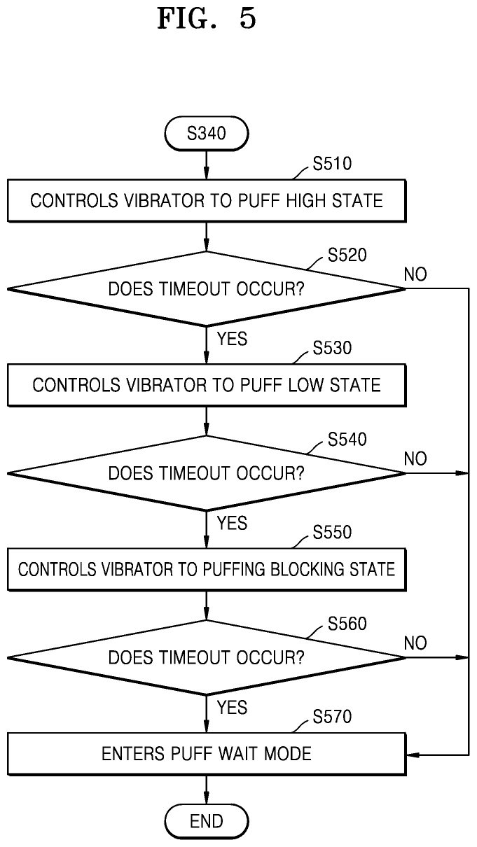

FIG. 5 is a flowchart illustrating another example of a method of controlling an aerosol generating device based on ultrasonic vibration, according to the present disclosure.

FIG. 5 is a flowchart particularly illustrating another example of implementing the puffing mode 450 in the control method described above with reference to FIG. 3. In FIG. 5, it is assumed that the user's puff is sensed in the puff wait mode 430 and then the vibrator 1300 enters the puffing mode 450. Hereinafter, descriptions will be made with reference to FIGS. 2 to 4.

In operation S510, a control signal of the puffing mode 450 received from the processor 1200 may control the vibrator 1300 to enter a puffing high state. In operation S510, the puffing high state means a state in which relatively high power is supplied to the vibrator 1300 for a certain time so that aerosols are generated through vibration of the vibrator 1300 which is operating in the puff wait mode 430.

In the puffing high state, a preset voltage may be applied to the vibrator 1300 for a preset time, and for convenience of explanation, in the puffing high state, a preset voltage applied to the vibrator 1300 and a section in which the voltage is maintained for a preset time are referred to as a first voltage and a first section, respectively. In addition, hereinafter, the occurrence of a timeout for a particular state means that a preset maintaining time has elapsed.

Then, when a timeout for the puffing high state occurs in operation S520, the vibrator 1300 may be controlled to a puffing low state by a control signal in operation S530. Here, in the puffing low state, a preset voltage may be applied to the vibrator 1300 for a preset time. For convenience of explanation, in the puffing low state, a preset voltage applied to the vibrator 1300 and a section in which the voltage is maintained for a preset time are referred to as a second voltage and a second section, respectively.

The first voltage applied to the vibrator 1300 is greater than the second voltage. As an example, the first voltage may be one voltage value selected from 12 V to 14 V, and the second voltage may be one voltage value selected from 9 V to 11 V. According to an embodiment, the first voltage may be 13 V, and the second voltage may be 10 V.

A time length of the first section may be the same as or different from a time length of the second section. In addition, the time lengths of the first section and the second section may be affected by a time length of a blocking section to be described below.

The processor 1200 determines whether a timeout for the second section, that is a maintaining section of the puffing low state, occurs, and when the timeout for the second section occurs in operation S540, the vibrator 1300 may receive a control signal from the processor 1200 to enter a puffing block state in operation S550.

No voltage is applied to the vibrator 1300 operating in the puffing block state. To prevent damage to the vibrator 1300 overheated in an operation of sufficiently operating to generate aerosols, in a puffing block mode, even if there is any input, an external signal is blocked for a certain time period so that the vibrator 1300 is not operated. A section which the vibrator 1300 maintains the puffing block state may be abbreviated as a blocking section similar to the first section and the second section.

The processor 1200 determines whether a timeout for the blocking section occurs, and when the timeout for the blocking section occurs in operation S560, the vibrator 1300 may receive a control signal from the processor 1200 to enter the puff wait mode in operation S570. As another example of operation S570, when a timeout for the blocking section occurs, the aerosol generating device 10000 may enter a sleep mode or power thereof is turned off to minimize battery 1100 power consumption in preparation for the user's next puff.

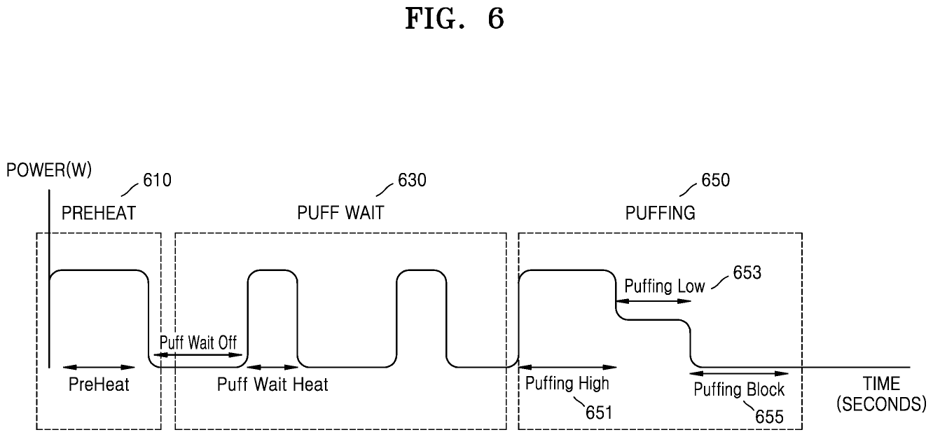

Schematic descriptions of the above-described first section, the second section, and the blocking section are described below with reference to FIG. 6.

FIG. 6 schematically illustrates a graph of time to power of a vibrator operating in a puffing mode.

Because descriptions of a preheat mode 610 and a puff wait mode 630 are the same as the descriptions of the preheat mode 410 and the puff wait mode 430 made with reference to FIG. 4, repeated descriptions are omitted hereinafter.

The puffing mode of the graph shown in FIG. 6 is different from the puffing mode of the graph shown in FIG. 4. In particular, in the puffing mode 450 of FIG. 4, the same voltage is applied to the vibrator 1300 during the puffing mode to generate aerosols, but the puffing mode 650 of FIG. 6 is divided into a puffing high state 651, a puffing low state 653, and a puffing block state 655, wherein aerosols are generated through an operation of applying a voltage to the vibrator 1300 only in the puffing high state 651 and the puffing low state 653, and no voltage is applied to the vibrator 1300 in the puffing block state 655.

The puffing mode 650 of FIG. 6 is characterized in being sequentially configured by the puffing high state 651, the puffing low state 653, and the puffing block state 655. Voltages applied to the vibrator 1300 in the puffing high state 651 and the puffing low state 653 are a first voltage and a second voltage, respectively, and as described with reference to FIG. 5, the first voltage may be one voltage value selected from 12 V to 14 V, and the second voltage may be one voltage value selected from 9 V to 11 V. According to an embodiment, the first voltage may be 13 V, and the second voltage may be 10 V.

A ratio between the duration of the first section (the duration of the puffing high state 651), the duration of the second section (the duration of the puffing low state 653), and the duration of the blocking section (the duration of the puffing block state 655) may be a preset value. For example, a ratio of time lengths of the first section, the second section, and the blocking section may be 2:3:1. Here, a suitable ratio may be selected as the ratio of the time lengths of the first section, the second section, and the blocking section to prevent the vibrator 1300 from being damaged and at the same time to stably generate aerosols, and this ratio may be an experimentally, empirically, andor mathematically predetermined value.

In FIG. 6, the puffing block state 655 is similar to the puff wait off section of the puff wait mode 630 in that the puffing block state 655 is a section in which no voltage is temporarily applied to the vibrator 1300. However, the puffing block state 655 has the following difference from the puff wait off section of the puff wait mode 630. In the puff wait off section, when the user's puff is sensed, the vibrator 1300 is immediately switched to the puffing mode 650 to generate an aerosol. Whereas, the puffing block state 655 is a section that forcibly blocks the operation of the vibrator 1300. That is, in the puffing block state 655, all signals are blocked even when the user's puff is detected, so that no voltage is applied to the vibrator 1300 to drive the vibrator 1300. This is because the aerosol has already been generated in the puffing high state 651 and the puffing low state 653 before the puffing block state 655.

An operation of the vibrator 1300 from the first section to the blocking section of the puffing mode 650 of FIG. 6 performs as follows. For convenience, it is assumed that the ratio of the time lengths of the first section to the blocking section is 2:3:1, and the first voltage and the second voltage are 13V and 10V, respectively.

The vibrator 1300, which has entered the puffing high state 651, operates for two seconds in a state in which a voltage of 13V is applied. Subsequently, when timeout occurs after two seconds has elapsed, the vibrator 1300 enters the puffing low state 653 and operates for three seconds in a state in which a voltage of 10 V is applied. When timeout occurs after three seconds has elapsed, the vibrator 1300 enters the puffing blocking state 655 and no voltage is applied to the vibrator 1300, and even when there is an external control signal, all signals are blocked and the puffing block state 655 is maintained for one second. When timeout for the puffing block state 655 occurs, the puffing mode 650 may be terminated, and the vibrator 1300 may be switched to the puff wait mode 630 as described with reference to FIG. 5.

Through the above operation, according to an embodiment of the present disclosure, the puffing mode 650 may be reasonably controlled, and the vibrator 1300 may be prevented from being damaged and aerosols in a uniform amount may be generated each time.

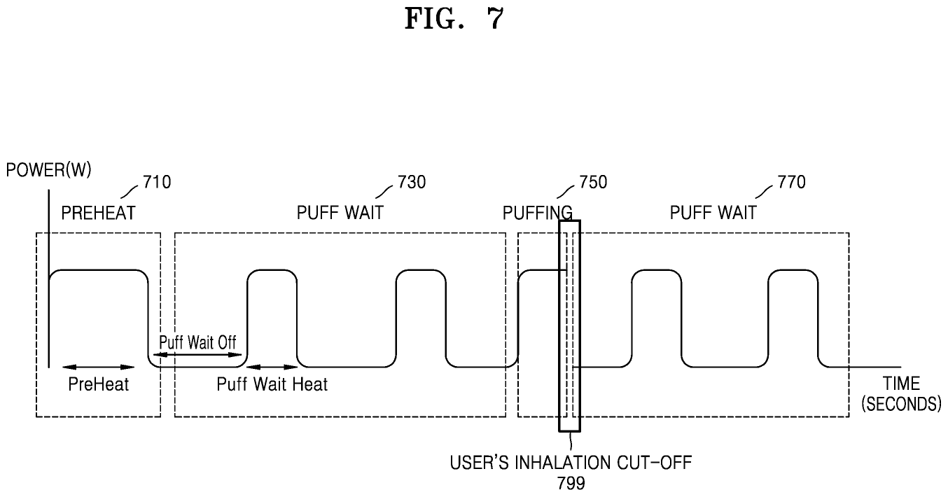

FIG. 7 is a graph illustrating a case in which an event is generated in a puffing high state.

In particular, FIG. 7 is a graph schematically showing operating characteristics of the vibrator 1300 when the user's inhalation cut-off 799 is sensed in the puffing high state 651 of the puffing mode 650 of FIG. 6 (referred to as puffing mode 750 in FIG. 7).

Because descriptions of a preheat mode 710 and a puff wait mode 730 are the same as the descriptions of the preheat mode 410 and the puff wait mode 430 made with reference to FIG. 4, repeated descriptions are omitted hereinafter.

When the processor 1200 senses that the user's inhalation is cut off through a puff detection sensor or the like while the vibrator 1300 of FIG. 7 enters a puffing mode 750 and operates by being applied with the first voltage according to the puffing high state, the puffing mode 750 is immediately terminated, and an operation mode of the vibrator 1300 is switched to a puff wait mode 770. Here, the puff wait mode 770 entered after the puffing mode 750 has the same characteristics as a puff wait mode 730 before the puffing mode 750.

In FIG. 7, a point at which the user's inhalation cut-off is sensed is before the timeout for the puffing high state occurs. For example, in the puffing high state maintained at the first voltage for two seconds after switching to the puffing mode 750, when the user's inhalation cut-off is sensed within one second after switching to the puffing mode 750, the vibrator 1300 may enter the puff wait mode 770.

A switching algorithm of the puff wait mode 770 as shown in FIG. 7 may prevent aerosols from being generated by unnecessarily applying a voltage to the vibrator 1300 even when the user's inhalation is not sensed. In addition, because the puffing low state and the puffing block state are omitted and the vibrator 1300 is immediately switched to the puff wait mode 770, the user may quickly inhale aerosols again.

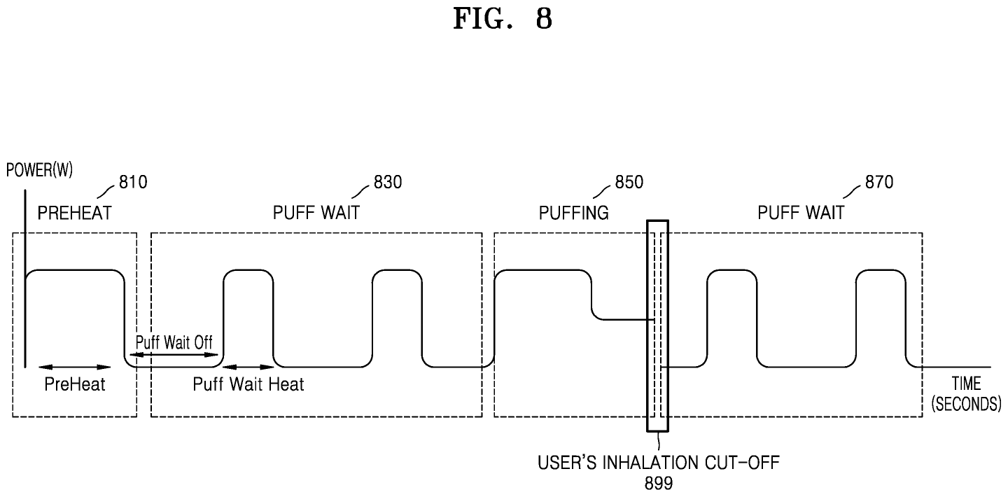

FIG. 8 is a graph illustrating a case in which an event is generated in a puffing low state.

In particular, FIG. 8 is a graph schematically showing operating characteristics of the vibrator 1300 when the user's inhalation cut-off 899 is sensed in the puffing low state 653 of the puffing mode 650 of FIG. 6.

Because descriptions of a preheat mode 810, a puff wait mode 830, and a puff wait mode 870 are the same as the descriptions of the preheat mode 410 and the puff wait mode 430 made with reference to FIG. 4, and the same as the descriptions of the puff wait mode 770 made with reference to FIG. 7, repeated descriptions are omitted hereinafter.

When the processor 1200 senses that the user's inhalation is cut off through a puff detection sensor or the like while the vibrator 1300 of FIG. 8 enters a puffing mode 850 and operates by being applied with the second voltage according to the puffing low state, the puffing mode 850 is immediately terminated, and an operation mode of the vibrator 1300 is switched to a puff wait mode 870. Here, the puff wait mode 870 entered after the puffing mode 850 has the same characteristics as a puff wait mode 830 before the puffing mode 850.

In FIG. 8, a point at which the user's inhalation cut-off is sensed is before the timeout for the puffing low state occurs. For example, in the puffing low state maintained at the second voltage for three seconds after switching to the puffing mode 850, when the user's inhalation cut-off is sensed within two seconds after switching to the puffing low state, the vibrator 1300 may enter the puff wait mode 870.

A switching algorithm of the puff wait mode 870 as shown in FIG. 8 may prevent aerosols from being generated by unnecessarily applying a voltage to the vibrator 1300 even when the user's inhalation is not sensed. In addition, because the puffing block state is omitted and the vibrator 1300 is immediately switched to the puff wait mode 870, the user may quickly inhale aerosols again.

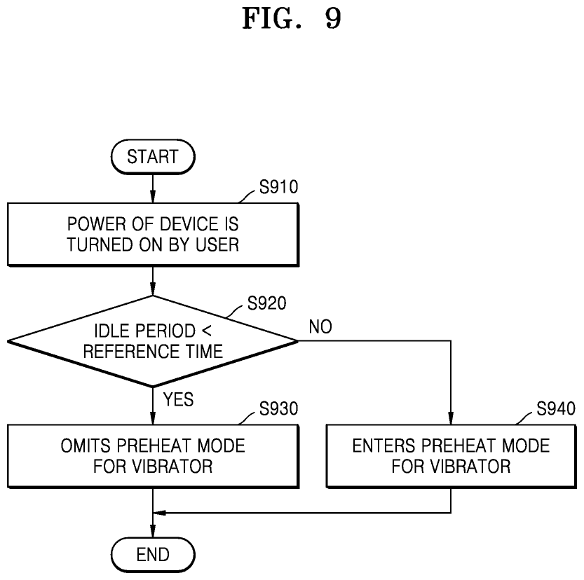

FIG. 9 is a flowchart illustrating another example of a method of controlling an aerosol generating device based on ultrasonic vibration, according to an embodiment of the present disclosure.

In more particular, FIG. 9 is a diagram for explaining an operation of omitting a preheat mode and immediately entering a puff wait mode in an aerosol generating device based on ultrasonic vibration, according to an embodiment the present disclosure. Like other flowcharts, FIG. 9 is described with reference to FIG. 2.

First, when the power of the aerosol generating device based on ultrasonic vibration is turned on by the user in operation S910, the processor 1200 determines whether an idle period of the aerosol generating device is less than a reference time in operation S920.

In operation S920, the idle period is a time value obtained by counting how long time has elapsed since the aerosol generating device has not been used by the user, and the processor 1200 may detect the idle period based on a recent time the aerosol generating device was used. The processor 1200 may detect a gap between the recent use time of the aerosol generating device stored in a memory and the current time as the idle period. As another example, the processor 1200 may also directly obtain the idle period based on a time counter separately provided to count the idle period.

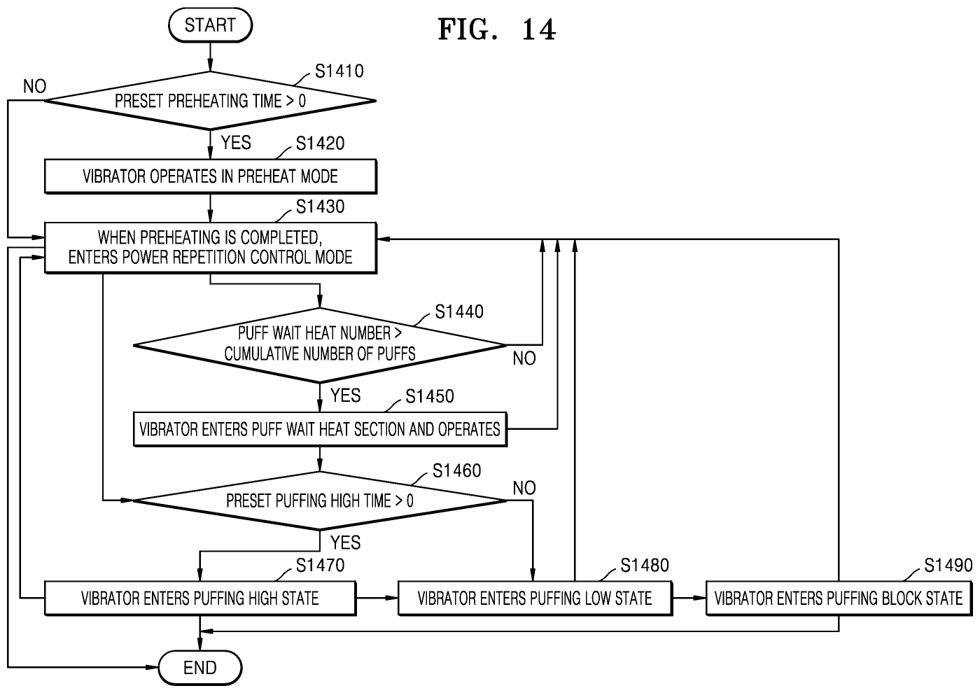

According to an embodiment, in operation S920, the processor 1200 may also determine to omit the preheat mode after determining whether a preset preheating time is set to a value greater than zero seconds, without detecting the idle period and comparing the idle period with the reference time. This embodiment is described below with reference to FIG. 14.

When the idle period is less than a preset reference time based on size, the processor 1200 may control the vibrator 1300 to directly enter the puff wait mode in operation S320 (refer to FIG. 3) and omit the preheat mode for the vibrator 1300 in operation S930.

On the other hand, when the idle period is greater than a preset reference time, the processor 1200 may control the vibrator 1300 to enter the preheat mode in operation S940 to increase the efficiency of aerosol generation.

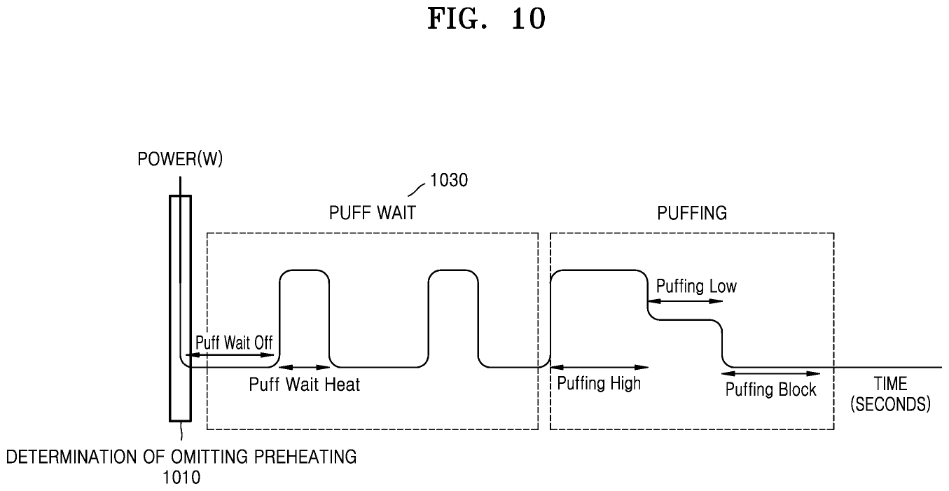

FIG. 10 schematically illustrates a graph of time versus power, in which a preheat mode is omitted.

Because descriptions of a puff wait mode 1030 is the same as the descriptions of the puff wait mode 430 made with reference to FIG. 4, repeated descriptions are omitted hereinafter.

Referring to the time axis of the graph of FIG. 10, the processor 1200 determines whether the preheat mode is omitted (1010) at a moment when the power of the aerosol generating device is turned on, and as the preheat mode is omitted, it may be seen that the vibrator 1300 immediately enters a puff wait mode 1030.

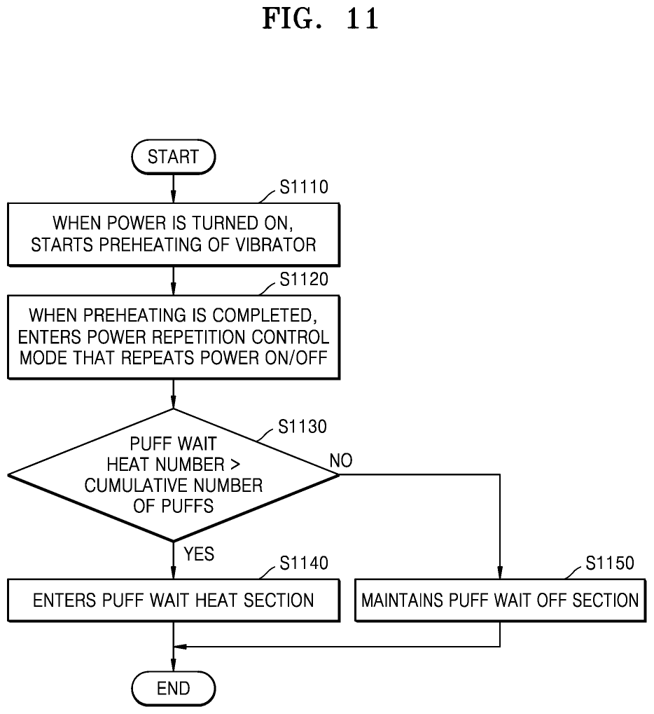

FIG. 11 is a flowchart illustrating another example of a method of controlling an aerosol generating device based on ultrasonic vibration, according to an embodiment of the present disclosure.

In more particular, FIG. 11 is a flowchart illustrating an embodiment in which the number of entries of a puff wait heat section in a puff wait mode (power repetition control mode) is pre-determined.

In operation S1110, when the power of the aerosol generating device 10000 based on ultrasonic vibration is turned on, the processor 1200 controls the vibrator 1300 to start preheating.

When the preheating of the vibrator 1300 is completed, the processor 1200 controls the vibrator 1300 to enter the power repetition control mode in operation S1120, and determines whether a preset puff wait heat number is greater than a cumulative number of puffs in operation S1130.

In operation S1130, the puff wait heat number means the number of times the vibrator 1300 enters the puff wait heat section in the power repetition control mode, and may be preset. In operation S1130, the cumulative number of puffs is the number of puffs accumulated by the user, and generally becomes zero unless the user continuously uses the device without turning off the power of the device.

When the puff wait heat number is set to an integer value greater than zero, the vibrator 1300 enters the puff wait heat section based on the preset puff wait heat number in operation S1140. A case in which the vibrator 1300 repeatedly and alternately enters the puff wait heat section and the puff wait off section in operation S1140 has already been described with reference to FIG. 4.

On the other hand, when the puff wait heat number is less than the cumulative number of puffs, the vibrator 1300 maintains the puff wait off section in operation S1150. In operation S1150, the puff wait off section may be maintained until the user turns off the power of the device or the user's puff is sensed and the device is switched to the puffing mode.

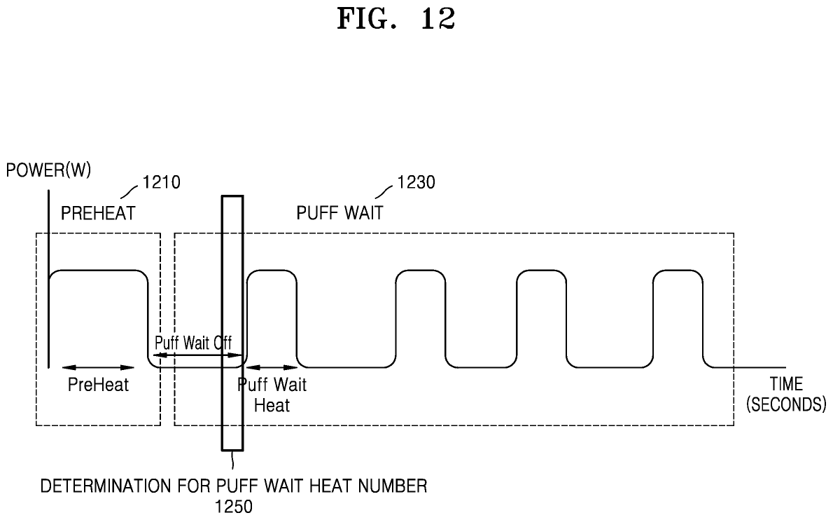

FIG. 12 is a graph schematically explaining the puff wait heat number described in FIG. 11.

Because descriptions of a preheat mode 1210 and a puff wait mode 1230 are the same as the descriptions of the preheat mode 410 and the puff wait mode 430 made with reference to FIG. 4, repeated descriptions are omitted hereinafter.

Referring to FIG. 12, it may be seen that the vibrator 1300, which has been primarily preheated, enters the puff wait off section once for device protection, and a preset puff wait heat number is determined by the processor 1200 in operation S1250.

As an example, when the puff wait heat number determined by the processor 1200 is four, and a cumulative number of puffs is zero, the number of times of entries of the puff wait heat section in a puff wait mode 1230 is a total of four times. Therefore, as shown in FIG. 12, it may be seen that the vibrator 1300 enters the puff wait heat section for a total of four times while alternately entering the puff wait heat section and the puff wait off section.

The embodiment described with reference to FIGS. 11 and 12 is an embodiment about how many times the puff wait heat section is generated in total until the user's puff is sensed in a state in which the preheating of the vibrator 1300 is completed. When an appropriate puff wait heat number is set, wastage of a battery 1100 of an aerosol generating device may be prevented while minimizing a length of a puff wait mode.

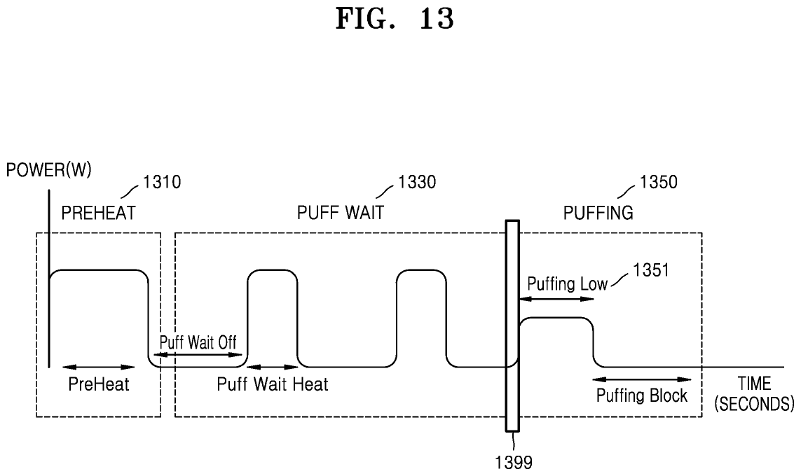

FIG. 13 illustrates a graph of time versus power supplied to a vibrator when a puffing high time is set to zero.

Because descriptions of a preheat mode 1310 and a puff wait mode 1330 are the same as the descriptions of the preheat mode 410 and the puff wait mode 430 made with reference to FIG. 4, repeated descriptions are omitted hereinafter.

As described with reference to FIG. 6, a puffing mode may include a puffing high state, a puffing low state, and a puffing block state. However, when the puffing high time, which determines the duration of the puffing high state, is set to zero, as soon as the vibrator 1300 enters the puffing mode, the vibrator 1300 may operate by immediately being applied with a voltage according to the puffing low state.

FIG. 13 schematically shows that the puffing high time is set to zero and a puffing low state 1351 is reached from a starting point of a puffing mode 1350. In particular, the processor 1200 may check the puffing high time at a point 1399 when a puff is sensed, and control the vibrator 1300 to enter and operate in the puffing low state 1351 based on the puffing high time being zero.

FIG. 14 is a flowchart comprehensively explaining embodiments shown in FIGS. 3 to 13.

In particular, FIG. 14 is a diagram in which the flowcharts illustrated in FIGS. 3, 5, 9, and 11 are integrated into one flowchart, and the processor 1200 may sequentially and repeatedly control an operation of the vibrator 1300 by generating control signals based on a control algorithm as shown in FIG. 14. By the vibrator 1300 controlled by a method according to FIG. 14, an aerosol generating device according to an embodiment of the present disclosure may be prevented from being damaged due to overheating of the vibrator 1300, and at the same time, may be controlled to produce a uniform amount of aerosols for each puff.

First, the processor 1200 determines whether a preset preheating time is greater than zero in operation S1410, and, when the preset preheating time is greater than zero, controls the vibrator 1300 to operate in the preheat mode in operation S1420.

When a timeout for the preheat mode occurs, the processor 1200 controls the vibrator 1300 to enter the power repetition control mode (puff wait mode) in operation S1430.

The processor 1200 may check whether a preset puff wait heat number is greater than a cumulative number of puffs after a first time of the puff wait off section has elapsed in operation S1440, and, when the puff wait heat number is greater than the cumulative number of puffs, control the vibrator 1300 to enter the puff wait heat section and operate in operation S1450.

The processor 1200 may control the vibrator 1300 to enter the puffing mode and operate when the user's puff is sensed while entering and operating in the puff wait heat section or the puff wait off section.

In addition, the processor 1200 may determine whether a preset puffing high time is greater than zero before the vibrator 1300 enters the puffing mode in operation S1460, and, only when the puffing high time is greater than zero, control the vibrator 1300 to enter the puffing high state and operate. In an embodiment, the vibrator 1300 may be applied with a voltage of 13 V for two seconds in the puffing high state as has been described above.

On the other hand, when the puffing high time is not greater than zero or a timeout for the puffing high state of the vibrator 1300 occurs, the processor 1200 may control the vibrator 1300 to enter the puffing low state and operate in operation S1480. In an embodiment, the vibrator 1300 may be applied with a voltage of 10 V for three seconds in the puffing low state as has been described above.

When a timeout for the puffing low state of the vibrator 1300 occurs, the processor 1200 may control the vibrator 1300 to enter the puffing block state in operation S1490. As described above, the vibrator 1300 that has entered the puffing block state may block a control signal for the vibrator 1300 for a certain period of time to protect the vibrator 1300 from being overheated while generating aerosols.

An aerosol generating device based on ultrasonic vibration according to an embodiment of the present disclosure is a device that operates in a preheat mode, a power repetition control mode (puff wait mode), and a puffing mode, and includes a control algorithm that prevents damage due to overheating of a vibrator and ensures a uniform amount of aerosols for each puff.

In particular, the aerosol generating device based on ultrasonic vibration according to an embodiment of the present disclosure may prevent overheating of the vibrator by entering a puff wait off section at least once after primary preheating is completed, and may block all user input by separately placing the vibrator into a puffing block state after the user's puff is completed and prevent a consuming use of the aerosol generating device.

In addition, the aerosol generating device based on ultrasonic vibration according to an embodiment of the present disclosure additionally includes a control algorithm that does not unnecessarily maintain the puffing mode when the user's inhalation is sensed and then quickly cut off.

Particular implementations described in the present disclosure are only examples, and do not limit the scope of embodiments of the present disclosure in any way. For the sake of brevity, conventional electronics, control systems, software development and other functional aspects of the systems may not be described in detail. Furthermore, the connecting lines, or connectors shown in the various figures presented are intended to represent example functional relationships and/or physical or logical couplings between the various elements. It should be noted that many alternative or additional functional relationships, physical connections or logical connections may be present in a device according to embodiments of the present disclosure. Moreover, no item or component is essential to the practice of the inventive concept unless the element is specifically described as “essential” or “critical”.

The use of the terms “a” and “an” and “the” and similar referents in the context of describing the present disclosure (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Also, the steps of all methods described herein can be performed in any suitable order unless otherwise indicated herein or otherwise clearly contradicted by context. Embodiments of the present disclosure are not limited to the described order of the steps. The use of any and all examples, or exemplary language (e.g., “such as”) provided herein, is intended merely to better illuminate embodiments of the present disclosure and does not pose a limitation on the scope of the present disclosure. Numerous modifications and adaptations will be readily apparent to one of ordinary skill in the art without departing from the spirit and scope of the present disclosure.

1. A method of controlling an aerosol generating device that generates an aerosol based on ultrasonic vibration of a vibrator of the aerosol generating device, the method performed by at least one processor, the method comprising:
operating, based on power of the aerosol generating device being turned on, the aerosol generating device in a preheat mode for preheating the vibrator;
operating, based on the preheat mode being completed, the aerosol generating device in a power repetition control mode wherein supplying of power to the vibrator and cutting off supply of the power to the vibrator are alternately repeated; and
operating, based on a puff of a user being sensed while operating in the power repetition control mode, the aerosol generating device in a puffing mode wherein power is supplied to the vibrator to generate the aerosol.

2. The method of claim 1, wherein the method further comprises switching from the power repetition control mode to the preheat mode based on repeating power control, of supplying the power to the vibrator and cutting off the supply of the power to the vibrator, a certain number of times.

3. The method of claim 1, wherein the preheat mode comprises applying a fixed amount of power to the vibrator during the preheat mode.

4. The method of claim 3, wherein a magnitude of a voltage applied in the preheat mode is any one voltage selected from 10 volts to 15 volts.

5. The method of claim 1, wherein the puffing mode sequentially comprises:
a first section of applying a first voltage to the vibrator;
a second section of applying a second voltage less than the first voltage to the vibrator; and
a blocking section of blocking a voltage to the vibrator.

6. The method of claim 5, wherein a ratio of time lengths of the first section, the second section, and the blocking section is a preset ratio value.

7. The method of claim 6, wherein the ratio of the time lengths is 2:3:1.

8. The method of claim 5, wherein the method further comprises switching from the puffing mode to the power repetition control mode based on an inhalation of the user ending before the first section ends.

9. The method of claim 5, wherein the method further comprises switching from the puffing mode to the power repetition control mode based on an inhalation of the user ending before the second section ends.

10. The method of claim 1, wherein the puffing mode sequentially comprises:
a second section of applying a second voltage less than a first voltage to the vibrator; and
a blocking section of blocking a voltage to the vibrator, and
wherein the operating in the puffing mode comprises operating by including the second section and the blocking section in the puffing mode, without operating in a first section before the second section, based on an obtained value for determining a length of the first section being less than or equal to zero, the first section being a section of applying the first voltage to the vibrator.

11. The method of claim 5, wherein the operating in the puffing mode comprises maintaining power blocking for the vibrator until the power blocking state ends, such that the voltage to the vibrator is blocked despite sensing of an inhalation of the user during the power blocking state.

12. The method of claim 1, wherein the operating in the power repetition control mode comprises controlling the vibrator with a pulse width modulation (PWM) signal having a duty cycle of a value selected from among a range of 40% to 60%.

13. The method of claim 1, wherein the method further comprises:
detecting, after the power of the aerosol generating device is turned on, an idle period based on a recent time the aerosol generating device is used, and
based on the detected idle period being less than a preset reference time, entering the power repetition control mode without first preheating the vibrator.

14. A non-transitory computer-readable recording medium storing a program for executing the method according to claim 1.

15. An aerosol generating device comprising:
a cartridge;
a vibrator configured to vibrate in response to a received control signal;
a vibration accommodation unit configured to receive vibration from the vibrator and vibrate an aerosol generating substrate discharged from the cartridge to generate an aerosol; and
a processor configured to generate at least one control signal for controlling the vibrator,
wherein the processor is further configured to:
operate, based on power of the aerosol generating device being turned on, in a preheat mode that includes controlling the vibrator to preheat, operate, based on the preheat mode being completed, in a power repetition control mode that includes causing supply of power to the vibrator and cutting off of the supply of power to the vibrator to be alternately repeated, and
operate, based on a puff of a user being sensed while operating in the power repetition control mode, in a puffing mode that includes causing power to be supplied to the vibrator to generate the aerosol.
